(19) United States
(12) Patent Application Publication
(10) Pub. No.: US 2016/0046467 A1
(43) Pub. Date: Feb. 18, 2016

(54) Cooling Ring

(71) Applicant: SIEMAG TECBERG GmbH, Haiger (DE)

(72) Inventors: Jakob Berns, Haiger (DE); Stephan Sonneborn, Bad Laasphe (DE)

(21) Appl. No.: 14/762,079

(22) PCT Filed: Jan. 16, 2014
(86) PCT No.: PCT/EP2014/050820

§ 371 Date: Oct. 30, 2015

(30) Foreign Application Priority Data
Feb. 4, 2013 (DE) 10 2013 001 949.4

(51) Int. Cl. B66D 1/28; H02K 9/04; B66D 1/12

(52) U.S. Cl. CPC B66D 1/28; B66D 1/12; H02K 9/04

(57) ABSTRACT

The invention relates to ventilation openings (10) integrated in at least one side plate (20) of the cable carrier (15) of a hauling machine (1). An electrical apparatus (35) is arranged in the interior of the cable carrier (15). A first air guide (30) covers the ventilation openings (10) in the side plate (20). The first air guide (30) is arranged for interactive air exchange with a second air guide (25), wherein the first air guide (30) is movable relative to the second air guide (20).

### BACKGROUND OF THE INVENTION

1. Field Of The Invention

The present invention relates to an apparatus for guiding cooling air into a hoisting machine.

2. Brief Description Of The Related Art

Due to the ever greater required performance of hoisting machines, growing demands are made with respect to cooling the electrical devices located in the rope carriers, such as drives or generators. Solutions have already been suggested, such as a hollow axle for feeding cooling air, on which axle the rope carrier is mounted, as well as guiding in and out of cooling air via the sides of the rope carriers by air hoods or stationary flow rings on the axle of the hoisting machine.

With performance of hoisting machines increasing all the time, the so far existing measures reach their limits economically and technically. Thus, in the case of a hollow axle, the inside diameter through which cooling air can flow is limited by excessive production costs among other things. In the case of stationary flow rings on the axle of the hoisting machine e.g. the bearings of the rope carrier disposed on the flow rings will necessarily have an ever increasing diameter in order to make an increased flow cross-section possible. This increase of the bearing diameter disadvantageously results in a cost increase of the bearings, and, in the case of a failure, to a prolonged reacquisition time of a replacement bearing. Further, when the performance of the hoisting machine increases and the flow cross-section of the hitherto existing solutions is limited, it can become necessary to additionally cool and/or climatize the fed cooling air, which causes further costs with regard to assembly and operation, and greater space requirements of the installation.

### SUMMARY OF THE INVENTION

It is consequently the object of the invention to provide an improved cooling-air guidance for hoisting machines, in order to counteract the above-mentioned disadvantages in hoisting machines with increased performance. This is achieved by an apparatus for guiding cooling air according to the features of the independent claim 1.

According to the invention, the rope carrier or the drum is air-cooled with forced ventilation, wherein the air is fed into and/or withdrawn from the rope carrier or the drum by means of an apparatus for guiding cooling air and one or a plurality of ventilators or blowers. This apparatus comprises at least one first air duct rotating along with the rope carrier and at least one second air duct that is static with reference to the rope carrier. The two air ducts are configured in mutually communicating fashion for air exchange or for guiding an air flow.

In order to cool the interior of the rope carrier as good as possible, it is desirable that the air blown into the interior of the rope carrier by ventilators or blowers on the one side of the rope carrier via the two air ducts is extracted or withdrawn by suction on the other side of the rope carrier via two further ones of the air ducts, utilizing at least one further ventilator or blower. For cost reasons, an one-sided air feed or extraction by means of the invention is likewise conceivable; in this case, the cooling air would flow in or out without support on one of the sides of the rope carrier.

According to the invention, the first and second air ducts can be configured in the form of rings running within each other. These are concentric rings, the diameter of which is chosen such that one ring fits into the other ring with a narrow gap on the outsides. Either of the first air duct and the second air duct can have the larger outside diameter. To improve the efficiency and/or reduce the loss of the air flow, all suitable seals can be used, such as by geometric configuration of the air ducts (e.g. labyrinth seals) or also by a seal attached to or inserted between the rings and in this case guided on one of the rings or several seals, as well as combinations of different types of seals. Further, preferably the rotating ring can be formed of a Z profile or a double-L profile, such that a chamber is created at the rope carrier, the chamber representing an additional volume for compensating pressure variations of the cooling air.

For the purpose of guiding the cooling air in and out, ventilation openings are provided in the lateral drum plates or side shields and in the side plates of the rope carriers surrounding the elements to be cooled. These ventilation openings can be covered by the first air duct, such that a permeable connection is established between the first air duct, the side shield and the interior of the rope carrier. Consequently, cooling air fed into the second (static) air duct can flow or be blown through this second air duct into the rotating first air duct, reaching the interior of the rope carrier and thus the elements to be cooled from there. Via ventilation openings in the opposite or second side shield the cooling air can thus flow out of or be withdrawn by suction from the rope carrier again. When it is intended to withdraw the cooling air in likewise guided fashion from the rope carrier, the cooling air enters a further, rotating-along air duct from the rope carrier through ventilation openings in the opposite or second side shield, flowing from said air duct into a further air duct associated with the rope carrier. The heated cooling air can then be guided away from this static air duct, possibly through the intermediary of a blower or ventilator.

The cooling air can be fed into the stationary air ducts via any type of inlet that is adapted to the ambient conditions. These can be air channels, tubes, pipes, etc. Also ventilators and/or blowers installed directly in the direct surroundings of the air ducts are conceivable.

### BRIEF DESCRIPTION OF THE DRAWINGS

Further characteristics and advantages of the invention may be taken from the following, purely descriptive and in no way limiting description of various embodiments of the invention with reference to the attached drawings. In particular, the characteristics of the various embodiments can also mutually be combined. In the attached drawings there is shown respectively:

FIG. 1 a hoisting machine of the state of the art having a hollow axle;

FIG. 2 a hoisting machine of the state of the art having a flow ring arranged on the axle between the bearing of the rope carrier and the axle;

FIG. 3 a sectional representation of a schematically represented hoisting machine, wherein the region X of the apparatus of the invention is represented in greater detail in the subsequent figures of the exemplary embodiments;

FIG. 4 a cutaway lateral view of a side plate with ventilation openings;

FIG. 5 a second embodiment representing the region X of FIG. 3 in more detail;

FIG. 6 a second embodiment representing the region X of FIG. 3 in more detail;

FIG. 7 the detailed representation of the region E of FIG. 6 of an optional seal between the first and the second air duct.

### DETAILED DESCRIPTION OF THE PREFERRED EMBODIMENTS

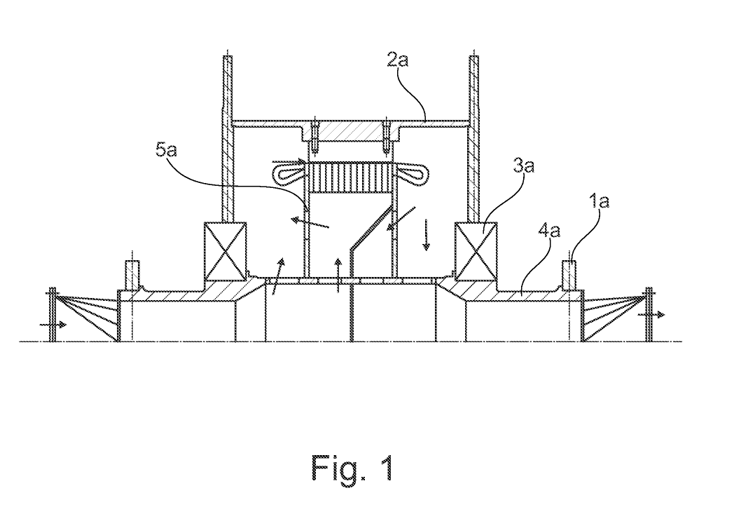

FIG. 1 shows a known hoisting machine, in which a rope carrier 2a is vented via a hollow main axle 4a. The rope carrier 3a is mounted on the hollow main axle 4a by means of bearings 3a arranged in mirror-image fashion, wherein the hollow main axle 4a is held by bearing supports 1a likewise arranged in mutual mirror-image fashion. In FIG. 1 the arrows indicate the air flow through the arrangement. This flow is fed to the hollow main axle 4a from the right side, then enters the rope carrier 2a through openings, flows through the electrical device 5a within the rope carrier 2a, reenters the hollow main axle 4a through openings and exits the arrangement on the left side. The complicated configuration of the hollow main axle 4a and the associated high manufacturing costs for the axle and the bearings 3a are disadvantageous in this solution.

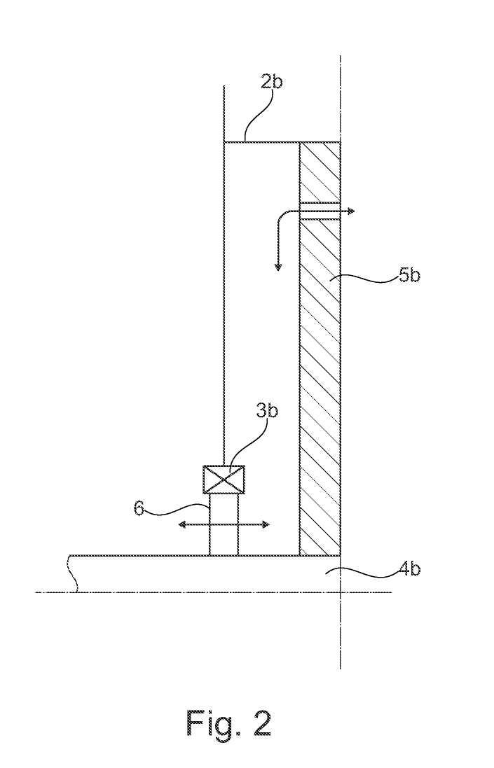

FIG. 2 shows a further known hoisting machine, wherein the cooling air (arrows) flows into a rope carrier 2 of a hoisting machine via a flow ring 6 and out of the rope carrier again on the opposite side. In so doing, the cooling air flows through the electrical device 5b to be cooled within the rope carrier 2b. The flow ring 6 is arranged between a conventional, non-rotating main axle 4b of the hoisting machine and a bearing 3b of the rope carrier 2b, necessarily increasing the diameter of the rope-carrier bearing 3b and thereby making the bearing 3b more expensive and making acquisition more difficult.

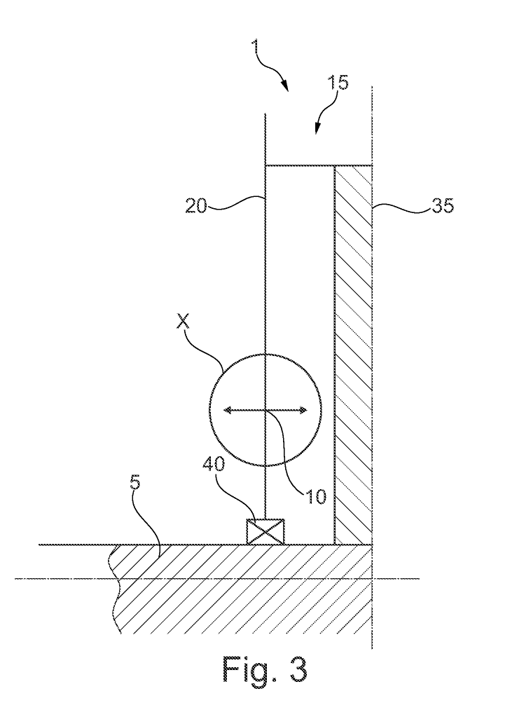

FIG. 3 shows a sectional representation of a schematic hoisting machine 1, which is of symmetrical design, wherein an axle 5 rotatably supports a rope carrier 15 with lateral drum plates or side plates 20 via a bearing 40. Within the rope carrier 15 there is arranged e.g. a known electrical drive or generator as electrical device 35, which is not addressed within the framework of this description, since it is not essential to the invention. The only condition applicable to this electrical device 35 within the framework of the description of this invention is that its configuration must be such that cooling air can flow through it. The side plate 20 has ventilation openings 10. The arrow in the region X marks the ventilation of the interior of the rope carrier 15 through the ventilation openings 10.

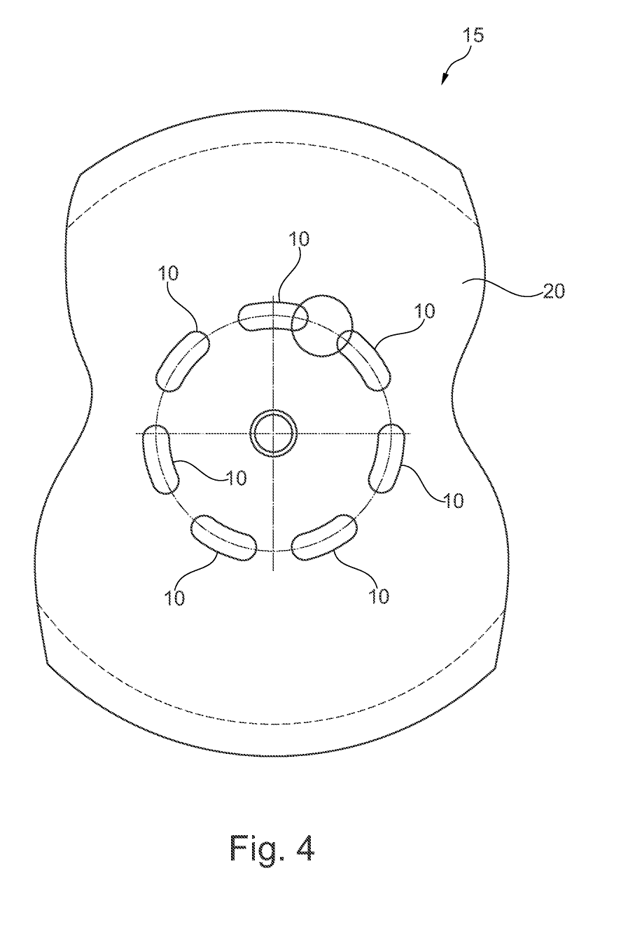

FIG. 4 shows a cutaway lateral view of the side plate 20 of the rope carrier 15 with seven of the ventilation openings 10. The number of ventilation openings 10 can be chosen as desired, which also applies to their position in the side plate 20. Further, it is not necessary that all ventilation openings 10 are disposed on the same circular path around the rotation center.

The subsequent description addresses embodiments of the invention which describe details of the region X more exactly. The characteristics stated in the description for FIG. 3 are applicable to all embodiments. In the description of the embodiments identical or similar parts bear the same reference numbers.

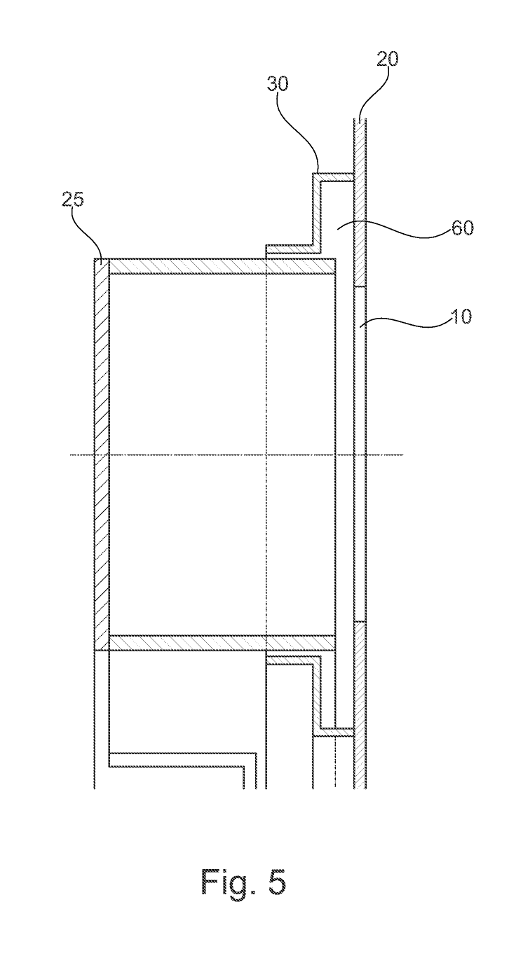

FIG. 5 shows a first embodiment of the invention with regard to the region X of FIG. 3. An annular first air duct 30 covers the ventilation openings 10 introduced in the side plate 20. The second air duct 25 protrudes into this first air duct 30 in contactless fashion, such that the rotating first air duct 30 and the static second air duct 25 substantially run free of contact. When the static second air duct 25 is loaded with cooling air coming from a blower or ventilator, the air exits from the second air duct 25 and is guided by the communicating connection of the first with the second air duct through the first air duct 30 rotating along with the side plate 20, further on to the ventilation opening 10 and through it into the interior of the rope carrier 15 in order to cool the electrical device 35 (not shown).

Through the Z shape or double-L shape of the first air duct 30 a compensation space 60 is created between the first air duct 30 and the side plate 20. This compensation space 60 helps compensate pressure variations of the cooling air that is fed via the second air duct 25.

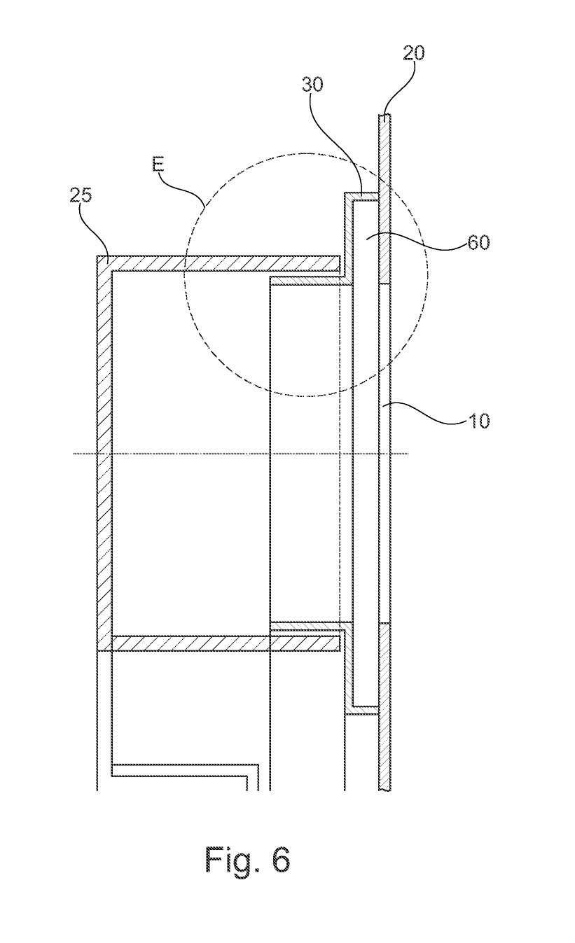

FIG. 6 shows a second embodiment of the invention, similar to the first embodiment of FIG. 5, wherein, in contrast to the first embodiment, the first air duct 30 runs free of contact within the second air duct 25.

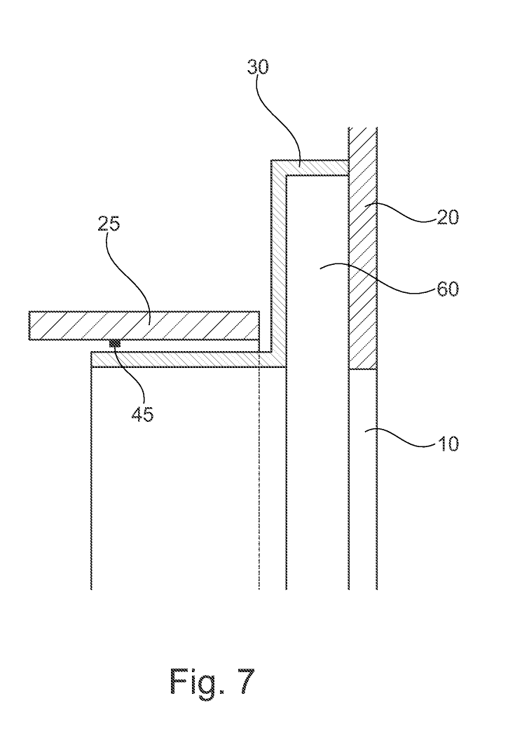

FIG. 7 shows the detail view of the region E of FIG. 6. A seal 45 is arranged here between the first air duct 30 and the second air duct 25. This seal 45 reduces the loss of cooling air at the junction from the first air duct 30 to the second air duct 25. The seal 45 can be produced of any suitable material. Materials with a low friction coefficient are to be preferred. Further, the seal 45 can be held in a defined position in either the first or the second air duct by a geometrical shape. This geometrical shape can be e.g. a groove. Further, also additional elements are conceivable which hold the seal 45 in the defined position or the seal 45 lies loosely between the rings. The above seal can also be applied when the rotating ring is arranged within the static ring or a seal is already provided by the geometric configuration of the two air ducts.

It is applicable to the above said that all structures which are described as ventilating or for blowing the cooling air into the rope carrier 15 can likewise be provided in mirror-image fashion on the other side of the rope carrier 15, in order to withdraw the heated cooling air from the rope carrier 15 again by suction. Further, in mutually independent fashion, a different embodiment of the invention can be used both on the feed side and on the extraction side. Moreover, it is possible to either blow in cooling air or withdraw the heated air by suction only on one side of the rope carrier 15 by means of one of the embodiments. For this purpose, it is only required to provide ventilation openings so that air can flow in or out. The features of the different embodiments can also be combined with each other independently.

Further, it is conceivable to configure the ventilation openings 10 geometrically such that, through the rotation of the rope carrier 15, they help feed the air to or extract the air from the interior of the rope carrier e.g. by structures like on a bucket wheel or turbine wheel.

Moreover, both the compensation space 60 and the seal 45 are characteristics which are not necessarily required for any of the embodiments.

1. A cooling air guiding apparatus of a hoisting machine having a rope carrier that is mounted on an axle and has side plates supplied with ventilation openings, and having an electrical device arranged within the rope carrier, comprising:
a first air duct covering the ventilation openings in one of said side plates; and
a second, static air duct in communication with the first air duct for exchanging air, wherein the first air duct is movable relative to the second air duct.

2. The apparatus according to claim 1, wherein both the first and the second air ducts are configured as concentric rings communicating for exchanging air.

3. The apparatus claim 1, wherein the cross-section area of the first air duct through which cooling air flows is of at least equal size as the cross-section area of the second air duct through which air flows.

4. The apparatus claim 1, wherein a seal is provided between the first and the second air duct.

5. The apparatus according to claim 4, wherein the seal is provided as a geometric design of the two air ducts.

6. The apparatus according to claim 4, wherein the seal is provided as at least one sealing element between the two air ducts.

7. The apparatus claim 1, wherein the second air duct can be loaded with an air flow.
